(19) United States
(12) Patent Application Publication
(10) Pub. No.: US 2006/0201912 A1
(43) Pub. Date: Sep. 14, 2006

(54) Method for reducing linewidth and size of metal, semiconductor or insulator patterns

(76) Inventor: Ja-Yong Koo, Daejeon (KR)

Correspondence Address: Patrick D. McPherson;Duane Morris LLP, Suite 700, 1667 K Street, N.W., Washington, DC, 20006, US

(21) Appl. No.: 11/281,401

(22) Filed: Nov. 18, 2005

(30) Foreign Application Priority Data
Mar. 11, 2005 (KR) 10-2005-0020405

(51) Int. Cl. B44C 1/22

(52) U.S. Cl. 216/83

(57) ABSTRACT

Disclosed herein is a method for forming metal, semiconductor or insulator patterns. The method comprises the steps of: (S302) forming metal, semiconductor or insulator patterns 202 with the larger sizes or linewidths by the prior method; and (S306) reducing the sizes or linewidths of the patterns 202 by etching the patterns 202 using a physical or mechanical process, or by etching the patterns 202 using a chemical process, or by decomposing the patterns 202 from the outermost portion thereof.

### BACKGROUND OF THE INVENTION

1. Field of the Invention

The present invention relates to a method for forming metal, semiconductor or insulator patterns, comprising forming metal, semiconductor or insulator patterns with large linewidth or size by the prior method and then reducing the size of the patterns by physical, chemical or mechanical etching.

2.Background of the Related Art

Generally, semiconductor devices are fabricated by performing various processes, including film deposition, oxidation, photolithography, etching, ion implantation, diffusion and the like on a semiconductor substrate, in a selective and repeated manner.

FIG. 1 is a flow chart showing a typical method of forming patterns by the prior photolithographic process. The method of forming semiconductor device patterns by the photolithographic process and subsequent processes will now be described.

First, photoresist is applied to a substrate (S102), the applied photoresist is soft-baked (S104), the edge portion of the wafer is exposed to light (S106), and then, a reticle is aligned on the wafer and exposed to light (S108).

After the alignment/exposure step (S108) has been performed, the wafer is subjected to post-exposure baking (PEB) (S110), and the wafer is developed (S112). The formed photoresist pattern is hard-baked (S114).

After the hard-baking step (S114), an etching or ion implantation step (S116) is performed using the photoresist as a mask. Then, the photoresist is removed (S118).

As a result, patterns made of metal, semiconductor or insulator, are made.

However, because of the limitation of the prior photolithographic technology it is almost impossible or difficult to fabricate a large amount of patterns with fine linewidth in such a manner that any patterns have a linewidth or size of less than 20 nm. However, in future high-performance devices, such fine patterns need to be formed. At present, methods developed to form patterns with a linewidth or size of the 20 nm level are only partially possible, or show very slow production rate, or require high production cost.

### SUMMARY OF THE INVENTION

The present invention is directed to a method of forming metal, semiconductor or insulator patterns, comprising forming patterns 202 with a large linewidth or size of, for example, more than 50 nm, and then, reducing the size of the formed patterns by physical, chemical or mechanical etching by using the conventional method. Thus, it is an object of the present invention to form fine patterns with small linewidth or size (e.g., less than 20 nm) at low costs while using the existing method suitable for mass production.

To achieve the above object, the present invention provides a method for forming metal, semiconductor or insulator patterns with fine size, the method comprising the steps of: forming metal, semiconductor or insulator patterns with a predetermined linewidth on a substrate; and reducing the size of the formed patterns by etching the patterns using physical or mechanical processing, or by etching the patterns using a chemical process, or by decomposing the patterns from the outermost portion thereof.

The inventive method preferably further comprises the step of thermally or chemically treating the patterns with the predetermined linewidth.

Also, the inventive method preferably further comprises the step of thermally or chemically treating the patterns with reduced linewidth.

Also, the inventive method preferably further comprises, after the step of forming the patterns with the predetermined linewidth, the step of etching or working at least one portion of the substrate.

Also, in the inventive method, the step of thermally or chemically treating the patterns is preferably applied in combination with the step of etching or working at least one portion of the substrate.

In the inventive method, the physical or mechanical processing is preferably ion beam processing.

Also, in the inventive method, the etching step using the chemical process is preferably carried out using an acid or alkali capable of etching the material of the patterns.

Also, in the inventive method, the material of the patterns with the predetermined linewidth is preferably a metal selected from the group consisting of aluminum, copper, nickel, iron, cobalt, molybdenum, tungsten, silver, gold, and other metals.

Also, in the inventive method, the step of reducing the size of the patterns by decomposing the patterns from the outermost portion thereof is preferably carried out by electrolysis.

### BRIEF DESCRIPTION OF THE DRAWINGS

FIG. 1 is a flow chart showing a process of forming patterns by the prior photolithographic process.

FIG. 2a is a cross-sectional view showing patterns with large size, formed on a substrate by the prior method.

FIG. 2b is a cross-sectional view showing patterns with fine small size, formed according to an embodiment of the present invention.

FIG. 3 is a flow chart showing a method of reducing the linewidth and size of metal, semiconductor or insulator patterns according to a first embodiment of the present invention.

FIG. 4 is a flow chart showing a method of reducing the linewidth and size of metal, semiconductor or insulator patterns according to a second embodiment of the present invention.

FIG. 5 is a flow chart showing a method of reducing the linewidth and size of metal, semiconductor or insulator patterns according to a third embodiment of the present invention.

FIG. 6a is a SEM image of metallic lines with the linewidth of around 250 nm, formed on a substrate by the prior method.

FIG. 6b is a SEM image of metallic lines with reduced linewidth below 20 nm, formed according to an embodiment of the present invention, employing the method of ion milling.

FIG. 7a is a SEM image of metallic dots with the diameter of around 160 nm, formed on a substrate by the prior method.

FIG. 7b is a SEM image of metallic dots with reduced diameter below 20 nm, formed according to an embodiment of the present invention, employing the method of ion milling.

### DETAILED DESCRIPTION OF THE PREFERRED EMBODIMENT

Hereinafter, preferred embodiments of the present invention will be described with reference to the accompanying drawings in order for a person skilled in the art to be able to practice the present invention.

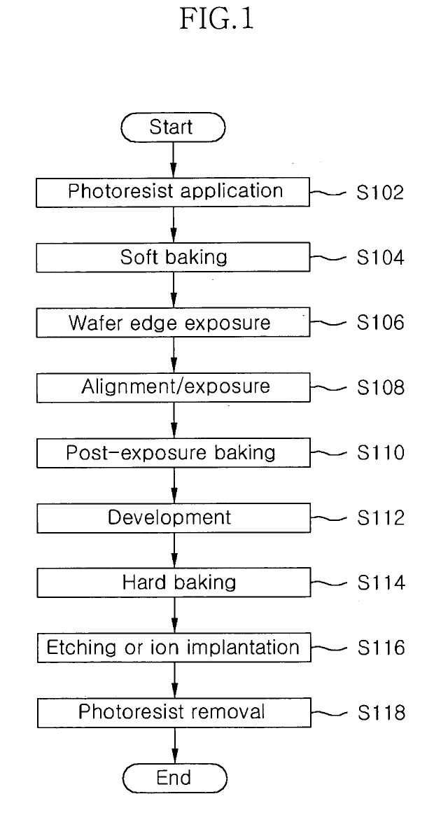

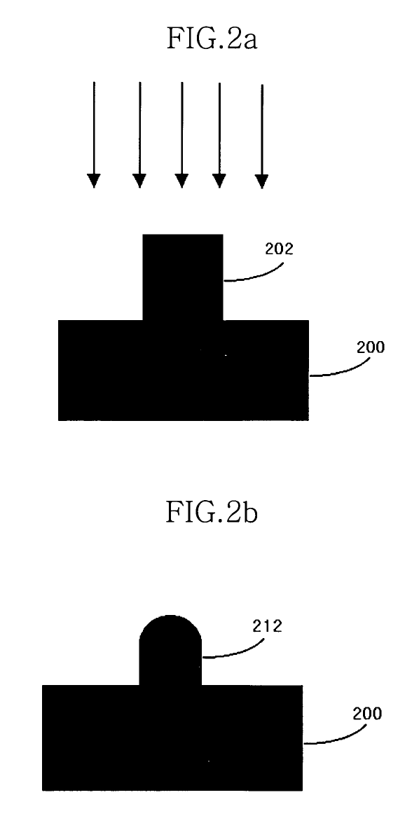

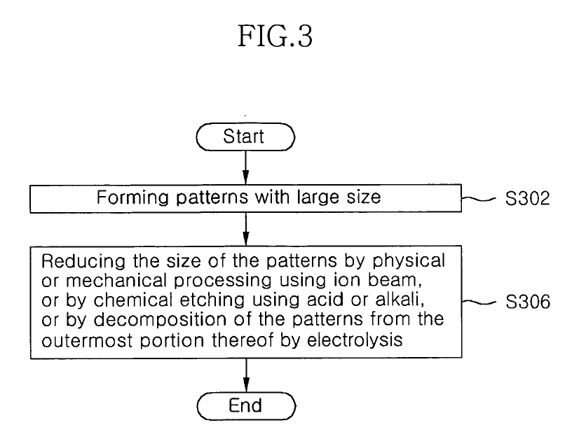

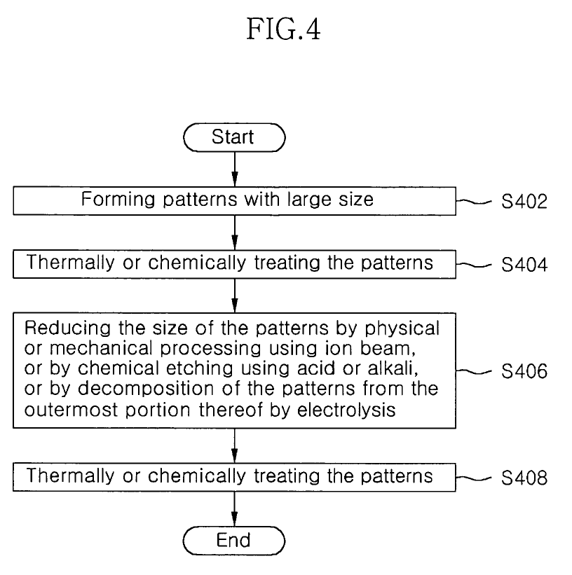

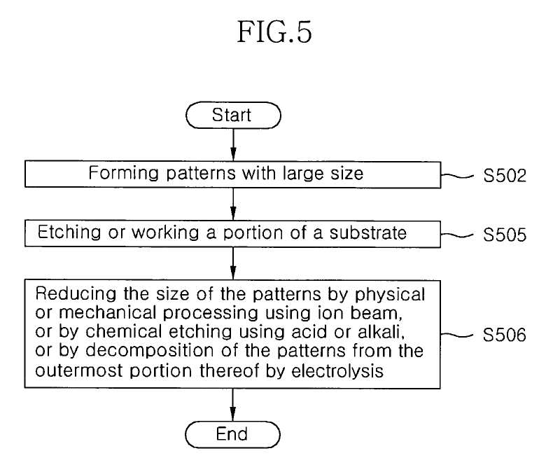

FIG. 1 is a flow chart showing a process of forming patterns by the prior photolithographic process; FIG. 2a is a cross-sectional view showing patterns with large size, formed on a substrate by the prior method; FIG. 2b is a cross-sectional view showing patterns with small size, formed according to an embodiment of the present invention; FIG. 3 is a flow chart showing a method of reducing the linewidth and size of metal, semiconductor or insulator patterns according to a first embodiment of the present invention; FIG. 4 is a flow chart showing a method of reducing the linewidth and size of metal, semiconductor or insulator patterns according to a second embodiment of the present invention; and FIG. 5 is a flow chart showing a method of reducing the linewidth and size of metal, semiconductor or insulator patterns according to a third embodiment of the present invention.

As shown in FIG. 3, the method of reducing the linewidth and size of metal, semiconductor and insulator patterns according to a first embodiment of the present invention comprises the steps of: (S302) forming patterns 202 with a large predetermined size on a substrate 200; and (S306) reducing the size of the patterns 202 by etching the patterns 202 using a physical or mechanical processing, such as ion beam processing, or by chemically etching the patterns 202 with an acid or alkali capable of etching the material of the patterns 202, or by decomposing the patterns 202 from the outermost portion thereof by, for example, electrolysis. Also, in order to increase the efficiency and uniformity of the selectively etched pattern surface, the method may further comprise the step of: (S404 or 408) subjecting the patterns to thermal or chemical treatment; or (S505) previously etching or working a portion of the substrate.

In FIGS. 3 to 5, the reference numerals with the same first-position number designate like steps. For example, the reference numerals S302, S402 and S502 designate like steps, and the reference numerals S306, S406 and S506 also designate like steps.

FIG. 3 is a flow chart showing the method of reducing the linewidth and size of metal, semiconductor or insulator patterns according to a first embodiment of the present invention. As shown in FIG. 3, in the step S302, the metal, semiconductor or insulator patterns 202 with large linewidth or size are formed according to the prior photolithographic technology. Such patterns 202 are shown in FIG. 2a.

In the step 306, the patterns 202 are etched by physical or mechanical processing, such as ion beam processing, so as to form the patterns 212 with fine size. Such fine patterns 212 are shown in FIG. 2b.

In another method of reducing the size of the patterns 202, the patterns 202 made of a metal selected from the group consisting of aluminum, copper, nickel, iron, cobalt, molybdenum, tungsten, and other metals are etched by a direct chemical process with a chemical substance, such as hydrochloric acid or nitric acid. Alternatively, the size of the patterns 202 can be reduced by decomposing the patterns 202 from the outermost portion thereof by electrolysis.

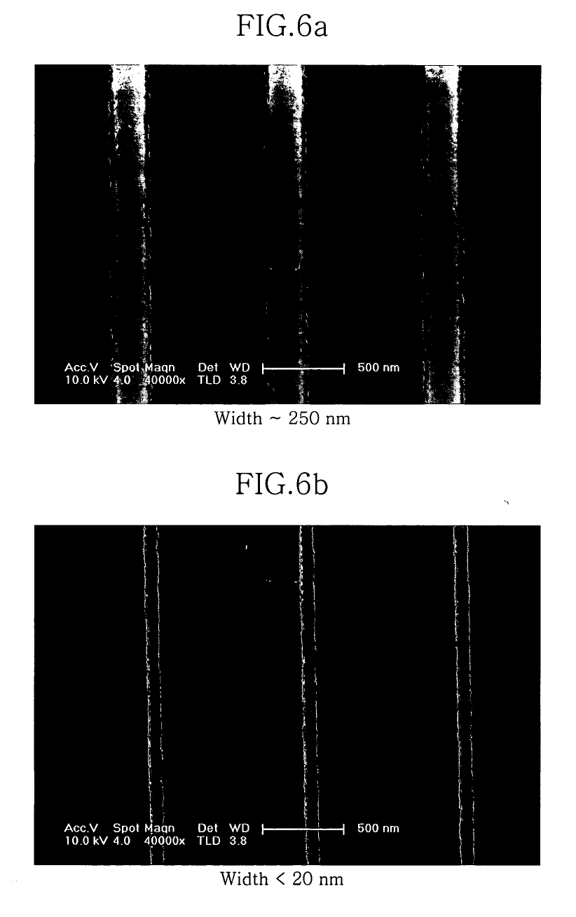

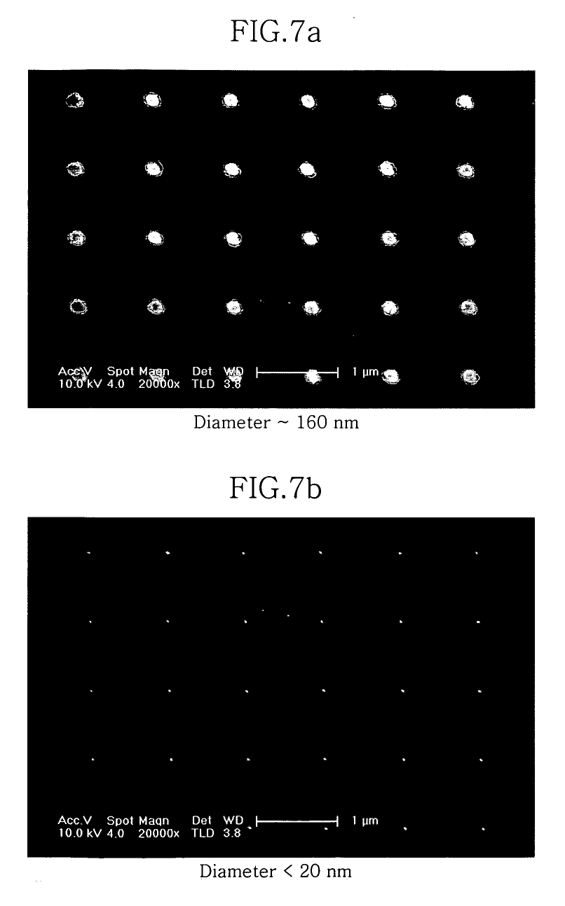

The above-described step S306 generally well works in a macroscopic system and was not reported at the 20 nm level, but is expected to be sufficiently applied if it is performed under strict management. A partial test results showed that this technique was effective for reducing the size of patterns as shown in FIG. 6a to FIG. 7b. FIGS. 6a and 6b represent SEM images of metallic lines with the linewidth of around 250 nm formed on a substrate by the prior method and metallic lines with reduced linewidth below 20 nm formed according to an embodiment of the present invention, employing the method of ion milling, respectively.

FIGS. 7a and 7b represent SEM images of metallic dots with the diameter of around 160 nm formed on a substrate by the prior method and metallic dots with reduced diameter below 20 nm formed according to an embodiment of the present invention, employing the method of ion milling, respectively.

FIG. 4 is a flow chart showing a method of reducing the linewidth and size of metal, semiconductor or insulator patterns according to a second embodiment of the present invention. As shown in FIG. 4, in the step S402, the metal, semiconductor or insulator patterns 202 with large linewidth or size are formed by the prior photolithographic technology.

In the step S404, the patterns 202 can be subjected to thermal or chemical treatment in order to increase the efficiency and uniformity of the etched surface. This step may also be performed in the step S408 after the step S406, but not after the step S402. The steps 404 and 408 are optionally carried out.

In the step S406, the patterns 202 are etched or processed by a physical or mechanical processing, such as ion beam processing, or etched by a direct chemical process with a chemical substance, such as hydrochloric acid or nitric acid. Alternatively, the size of the patterns 202 can be reduced by decomposing the patterns from the outermost portion thereof by electrolysis.

As described above, if the step S404 is not performed, the step S408 will be performed. The step S408 is carried out the same manner as the step S404.

FIG. 5 is a flow chart showing a method of reducing the linewidth and size of metal, semiconductor or insulator patterns according to a third embodiment of the present invention. As shown in FIG. 5, in the step S502, the metal, semiconductor or insulator patterns 202 with large line width or size are formed on a substrate by the prior photolithographic technology.

In the step S505, a portion of the substrate is etched or worked in order to increase the efficiency and uniformity of etching.

In the step S506, the patterns 202 are etched or processed by a physical or mechanical processing, such as ion beam processing, or etched by a direct chemical process with a chemical substance, such as hydrochloric acid or nitric acid. Alternatively, the size of the patterns 202 can be reduced by decomposing the patterns from the outermost portion thereof by electrolysis.

Although the present invention has been described mainly with respect to the above embodiments, various modifications, additions and substitutions are possible, without departing from the scope and spirit of the invention. For example, the combined application of the step S404 of subjecting the patterns to thermal or chemical treatment so as to increase the efficiency and uniformity of the etched surface and the step S505 of previously etching or working a portion of the substrate in order to increase the efficiency and uniformity of etching will be apparent to a person skilled in the art from the above description of the embodiments.

The present invention relates to the method of forming metal, semiconductor or insulator patterns, comprising forming the patterns 202 with a larger linewidth or size than, for example, 50 nm, by the existing process, and then, reducing the size of the formed patterns by physical, chemical or mechanical etching. Thus, since the patterns 202 with large size, which have been formed by the existing method in large amounts, are used in the present invention, the present invention has an economic advantage in that the existing technology and equipment are used as they are.

Also, the inventive method of simply reducing the linewidth or size of the formed patterns 202 is performed in a very easy and cost-effective manner and has high yield. Also, the present invention allows the formation of the fine patterns 212 which cannot be made by the existing method, and thus, the present invention will contribute to improvements in the performance of devices.

Although preferred embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. A method for forming metal, semiconductor or insulator patterns, the method comprising the steps of:
forming metal, semiconductor or insulator patterns with a predetermined linewidth on a substrate; and
reducing the size of the formed patterns by etching the patterns using physical or mechanical processing, or by etching the patterns using a chemical process, or by decomposing the patterns from the outermost portion thereof.

2. The method of claim 1, which further comprises the step of thermally or chemically treating the patterns with the predetermined linewidth.

3. The method of claim 1, which further comprises the step of thermally or chemically treating the patterns with reduced linewidth.

4. The method of claim 1, which further comprises, after the step of forming the patterns with the predetermined linewidth, the step of etching or working at least one portion of the substrate.

5. The method of claim 4, wherein the step of thermally or chemically treating the patterns is applied in combination with the step of etching or working at least one portion of the substrate.

6. The method of claim 1, wherein the physical or mechanical processing is ion beam processing.

7. The method of claim 1, wherein the etching step using the chemical process is carried out using an acid or alkali capable of etching the material of the patterns.

8. The method of claim 1, wherein the material of the patterns with the predetermined linewidth is a metal selected from the group consisting of aluminum, copper, nickel, iron, cobalt, molybdenum, tungsten, silver, gold, and other metals.

9. The method of claim 1, wherein the step of reducing the size of the patterns by decomposing the patterns from the outermost portion thereof is carried out by electrolysis.

10. The method of claim 1, wherein the size of the patterns with reduced linewidth is less than 20 nm.
